(19) United States
(12) Patent Application Publication
(10) Pub. No.: US 2006/0133422 A1
(43) Pub. Date: Jun. 22, 2006

(54) Maintaining message boundaries for communication protocols

(76) Inventors: Robert R. Maughan, Colorado Springs, CO (US); Robert W. Cone, Portland, OR (US); Miles F. Schwartz, West Linn, OR (US); Anshuman Thakur, Beaverton, OR (US)

Correspondence Address: INTEL CORPORATION, P.O. BOX 5326, SANTA CLARA, CA, 95056-5326, US

(21) Appl. No.: 11/021,710

(22) Filed: Dec. 22, 2004

(51) Int. Cl. H04J 3/24

(52) U.S. Cl. 370/474

(57) ABSTRACT

In an embodiment, a method is provided. The method of this embodiment provides creating a segmentable message based, at least in part, on a transmit PDU (protocol data unit) instruction, the segmentable message having one or more PDUs, creating an MSB (message segmentation block) corresponding to the segmentable message, and transmitting the segmentable message using the corresponding MSB.

### FIELD

Embodiments of this invention relate to maintaining message boundaries for communication protocols.

### BACKGROUND

The Open Systems Interconnection Reference Model (hereinafter “OSI model”) is a layered abstract description for communications and computer network protocol design, developed as part of the Open Systems Interconnect initiative. The OSI model is defined by the International Organization for Standardization (ISO) located at 1 rue de Varembé, Case postale 56 CH-1211 Geneva 20, Switzerland. The OSI model divides communications functions into a series of layers. Each layer may implement a protocol that governs how one system communicates with another system. Although the OSI model describes 7 layers, typical implementations use a set of lower layers (typically layers 1-4), and an upper layer. The lower layers may include:

Physical Layer (Layer 1) to, for example, establish and terminate connections to a communication medium, and to perform modulation.

Data Link Layer (Layer 2) to, for example, provide functional and procedural means to transfer data and detect errors that may occur in the Physical Layer.

Network Layer (Layer 3) to, for example, provide functional and procedural means to transfer variable length data, routing, and flow control. May perform segmentation and reassembly of packets.

Transport Layer (Layer 4) to, for example, perform transparent transfer of data between end processes. May perform segmentation and reassembly of packets.

Upper Layer: this layer may perform any combination of functions performed by the OSI model Session Layer (Layer 5), Presentation Layer (Layer 6), and/or Application Layer (Layer 7), including, for example, syntax and semantics conversion, and managing dialogue between end-user application processes.

A protocol data unit (hereinafter “PDU”) may be generated by an Upper Layer Protocol (hereinafter “ULP”) and be sent to a lower layer for segmentation. However, some ULPs may generate communications in which the message boundaries should be preserved.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a system according to an embodiment.

FIG. 2 is a flowchart illustrating a method according to an embodiment.

FIG. 3 illustrates a transmit PDU instruction according to an embodiment.

FIG. 4 illustrates a segmentable message according to an embodiment.

FIG. 5 is a flowchart illustrating a method to generate a PDU from a transmit PDU instruction.

FIG. 6 illustrates a message segmentation block according to an embodiment.

FIG. 7 is a flowchart illustrating a method to create a message queue according to an embodiment.

FIG. 8 illustrates a message queue according to an embodiment.

FIG. 9 illustrates a message segmentation block generated from a segmentable message according to an embodiment.

FIG. 10 is a flowchart illustrating a method to transmit one or more segments of a segmentable message.

FIG. 11 is a flowchart illustrating method for retransmitting one or more segments of a segmentable message

FIG. 12 illustrates transmission of one or more segments of a segmentable message according to an embodiment.

FIG. 13 is a flowchart illustrating a method to receive an acknowledgement of receipt of one or more segments of a segmentable message according to an embodiment.

FIG. 14 illustrates acknowledgement of receipt of one or more segments of a segmentable message according to an embodiment.

FIG. 15 is a flowchart that illustrates a method to determine whether an MSB 1404 that corresponds to a segmentable message 1400 also corresponds to an acknowledgement.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

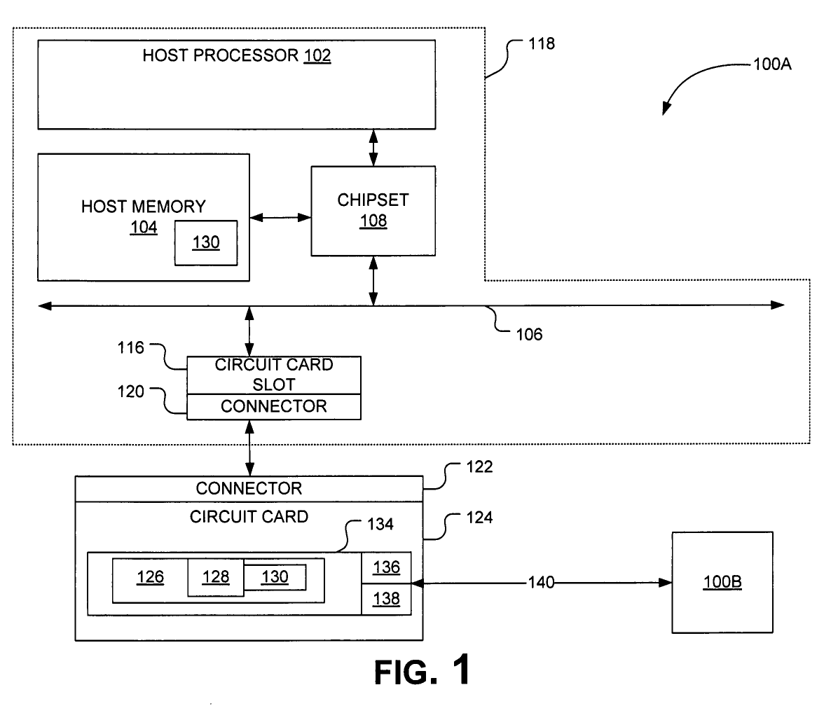

FIG. 1 illustrates a system in an embodiment. System 100A may comprise host processor 102, bus 106, chipset 108, circuit card slot 116, and connector 120. System 100A may comprise more than one, and/or other types of processors, buses, chipsets, circuit card slots, and connectors; however, those illustrated are described for simplicity of discussion. Host processor 102, bus 106, chipset 108, circuit card slot 116, and connector 120 may be comprised in a single circuit board, such as, for example, a system motherboard 118.

Host processor 102 may comprise, for example, an Intel® Pentium® microprocessor that is commercially available from the Assignee of the subject application. Of course, alternatively, host processor 102 may comprise another type of microprocessor, such as, for example, a microprocessor that is manufactured and/or commercially available from a source other than the Assignee of the subject application, without departing from this embodiment.

Chipset 108 may comprise a host bridge/hub system that may couple host processor 102, and host memory 104 to each other and to bus 106. Chipset 108 may include an I/O bridge/hub system (not shown) that may couple a host bridge/bus system of chipset 108 to bus 106. Alternatively, host processor 102, and/or host memory 104 may be coupled directly to bus 106, rather than via chipset 108. Chipset 108 may comprise one or more integrated circuit chips, such as those selected from integrated circuit chipsets commercially available from the Assignee of the subject application (e.g., graphics memory and I/O controller hub chipsets), although other one or more integrated circuit chips may also, or alternatively, be used.

Bus 106 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, for example, bus 106 may comprise a bus that complies with the PCI Express Base Specification, Revision 1.0a, Apr. 15, 2003 available from the PCI Special Interest Group (hereinafter referred to as a “PCI Express bus”). Bus 106 may comprise other types and configurations of bus systems.

One or more memories of system 100A may store machine-executable instructions 130 capable of being executed, and/or data capable of being accessed, operated upon, and/or manipulated by circuitry, such as circuitry 126. For example, these one or more memories may include host memory 104, and/or memory 128. One or more memories 104 and/or 128 may, for example, comprise read only, mass storage, random access computer-accessible memory, and/or one or more other types of machine-accessible memories. The execution of program instructions 130 and/or the accessing, operation upon, and/or manipulation of this data by circuitry 126 may result in, for example, system 100A and/or circuitry 126 carrying out some or all of the operations described herein.

Circuit card slot 116 may comprise a PCI expansion slot that comprises a PCI bus connector 120. PCI bus connector 120 may be electrically and mechanically mated with a PCI bus connector 122 that is comprised in circuit card 124. Circuit card slot 116 and circuit card 124 may be constructed to permit circuit card 124 to be inserted into circuit card slot 116.

When circuit card 124 is inserted into circuit card slot 116, PCI bus connectors 120, 122 may become electrically and mechanically coupled to each other. When PCI bus connectors 120, 122 are so coupled to each other, circuitry 126 in circuit card 124 may become electrically coupled to bus 106. When circuitry 126 is electrically coupled to bus 106, host processor 102 may exchange data and/or commands with circuitry 126, via bus 106 that may permit host processor 102 to control and/or monitor the operation of circuitry 126.

Circuitry 126 may comprise computer-readable memory 128. Memory 128 may comprise read only and/or random access memory that may store program instructions 130. These program instructions 130, when executed, for example, by circuitry 126 may result in, among other things, circuitry 126 executing operations that may result in system 100A carrying out the operations described herein as being carried out by system 100A, circuitry 126, and/or network device 134.

Circuitry 126 may comprise one or more circuits to perform one or more operations described herein as being performed by circuitry 126 and/or by system 100A. These operations may be embodied in programs that may perform functions described below by utilizing components of system 100A described above. Circuitry 126 may be hardwired to perform the one or more operations. For example, circuitry 126 may comprise one or more digital circuits, one or more analog circuits, one or more state machines, programmable circuitry, and/or one or more ASIC's (Application-Specific Integrated Circuits). Alternatively, and/or additionally, circuitry 126 may execute machine-executable instructions to perform these operations.

Circuitry 126 may comprise transmitter 136 and receiver 138 coupled to a communication medium 104, although transmitter 136 and receiver 138 need not be part of circuitry 134 in one or more embodiments. Transmitter 136 may transmit, and receiver 138 may receive, respectively, one or more signals and/or packets via medium 104. As used herein, a “communication medium” means a physical entity through which electromagnetic radiation may be transmitted and/or received. Medium 104 may comprise, for example, one or more optical and/or electrical cables, although many alternatives are possible. For example, communication medium 104 may comprise air and/or vacuum, through which systems may wirelessly transmit and/or receive sets of one or more signals. Communication medium 104 may couple together one or more systems 100A, 100B (only two shown) in a network. Systems 100A, 100B may transmit and receive sets of one or more signals via communication medium 104. For example, system 100A may be a transmitting node, and system 100B may be a receiving node. As used herein, a “packet” means a sequence of one or more symbols and/or values that may be encoded by one or more signals transmitted from at least one transmitting node to at least one receiving node.

In an embodiment, communications carried out, and signals and/or packets transmitted and/or received among two or more of the systems 100A, 100B via medium 104 may be compatible and/or in compliance with an Ethernet communication protocol (such as, for example, a Gigabit Ethernet communication protocol) described in, for example, Institute of Electrical and Electronics Engineers, Inc. (IEEE) Std. 802.3, 2000 Edition, published on Oct. 20, 2000. Of course, alternatively or additionally, such communications, signals, and/or packets may be compatible and/or in compliance with one or more other communication protocols.

Instead of being comprised in circuit card 124, some or all of circuitry 126 may instead be comprised in host processor 102, or chipset 108, and/or other structures, systems, and/or devices that may be, for example, comprised in motherboard 118, and/or communicatively coupled to bus 106, and may exchange data and/or commands with one or more other components in system 100A.

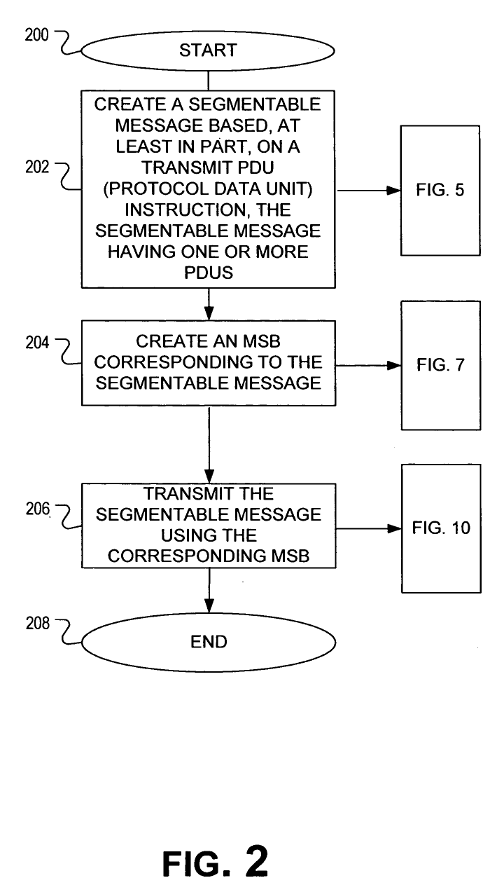

In an embodiment, circuitry 126 may be comprised in a network controller, such as, for example, a NIC (network interface card). NIC 134 may be wireless, for example, and may comply with the IEEE (Institute for Electrical and Electronics Engineers) 802.11 standard. The IEEE 802.11 is a wireless standard that defines a communication protocol between communicating systems and/or stations. The standard is defined in the Institute for Electrical and Electronics Engineers standard 802.11, 1997 edition, available from IEEE Standards, 445 Hoes Lane, P.O. Box 1331, Piscataway, N.J. 08855-1331. Network device 234 may be implemented in circuit card 224 as illustrated in FIG. 2. Alternatively, network controller circuitry 126 may be built into motherboard 118, for example, without departing from embodiments of the invention. As another alternative, circuitry 126 may comprise circuitry of a TCP/IP (transport control protocol/Internet protocol) offload engine (hereinafter“TOE”) without departing from embodiments of the invention. TOE may offload TCP/IP processing from a host processor, such as host processor 102.

In an embodiment, a packet may comprise a PDU, or portion thereof. As used herein, a “PDU” refers to a unit of data that is specified in a protocol of a given layer and that consists of protocol-control information of the given layer and possibly user data of that layer. The basic structure of a PDU may comprise a header and payload. Depending on the protocol, additional fields may be required, such as pad bytes to align the payload, a CRC (cyclic redundancy check) digest to cover the entire PDU, a CRC to cover the payload, or a fixed interval marker. A message may be generated from one or more PDUs.

A transmitting node of a message may perform segmentation to segment the message. “Segmentation” refers to breaking a message into smaller PDU pieces so that the pieces may be transmitted, for example, to accommodate restrictions in the communications channel, or to reduce latency. A receiving node may perform reassembly to reassemble the PDU pieces. “Reassembly” refers to joining the PDU pieces together in the right order to form a message.

Some ULPs, such as message-oriented communication protocols that generate messages, may generate communications in which message boundaries should be preserved. An example of such a ULP is RDMA (Remote Direct Memory Access), where a message may comprise a self-contained unit of data in which boundaries are preserved to simplify processing by the receiving node. RDMA is further described in “An RDMA Protocol Specification”, Internet Draft, Sep. 2, 2004, by Remote Direct Data Placement Work Group of the Internet Engineering Task Force (IETF). Embodiments of the invention, however, should not be limited to RDMA, or to protocols that create RDMA-type messages. Instead, embodiments of the invention should be understood as being generally applicable to any type of protocol in which message boundaries need to be, or are desired to be, preserved.

In an embodiment, the methods described herein may be performed by circuitry 126 in, for example, a NIC. Specifically, some methods may be performed by transmitter 136 of, for example, a NIC, and some methods may be performed by receiver 138 of, for example, a NIC. However, embodiments are not limited to NIC implementations, and other implementations are possible. For example, circuitry 126 may instead be comprised in a TOE, or on motherboard 118 without departing from embodiments of the invention.

FIG. 2 illustrates a method according to an embodiment. The method begins at block 200 and continues to block 202 where a segmentable message having one or more PDUs may be created based, at least in part, on a transmit PDU instruction. As used herein, a “segmentable message” refers to a message having one or more PDUs, where each PDU may be generated from a transmit PDU instruction, and where the message has a structure that may be segmented. A message may be generated from an ULP. A “transmit PDU instruction” refers to an instruction that may be used to generate one or more protocol-independent PDUs (unless otherwise indicated, hereinafter “PDU”), where a protocol-independent PDU refers to a PDU that is not specific to any particular protocol. A transmit PDU instruction may further refer to an instruction that may be used to generate one or more message segmentation blocks (hereinafter “MSBs”) to maintain message boundaries. Thus, a transmit PDU instruction may comprise one or more rules to create PDUs and/or MSBs.

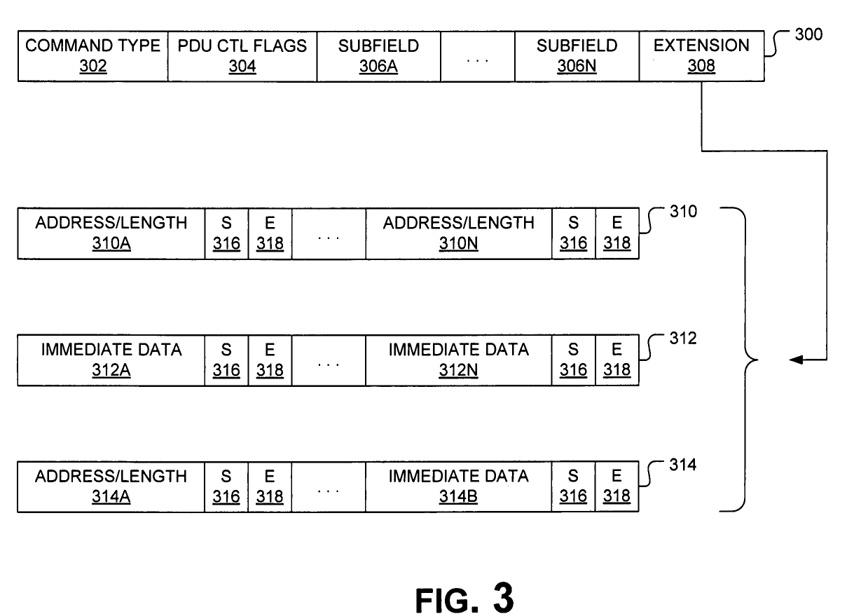

FIG. 3 illustrates an example of a transmit PDU instruction 300. A transmit PDU instruction 300 may comprise one or more of the following fields:

Command Type 302: this field may specify the protocol type. For example, this field may specify the RDMA protocol.

PDU Control Flags 304 (labeled “PDU CTL FLAGS”) and corresponding subfields 306A, . . . , 306N: this field may comprise one or more flags 304, where each flag may specify treatment of PDUs, such as may be required by the protocol specified in the “Command Type” field. A flag 304 may include one or more subfields 306A, . . . , 306N. The flags 304 and corresponding subfields 306A, . . . , 306N, if any, may include:

1. P (Pad Enable): when set, this flag may direct that the instruction add 0's to the end of the PDU. This flag may be associated with one or more subfields, where the value of the one or more subfields may include:

a. Pad Pattern, for example 0x0000000, 0x1111111.

b. Pad Alignment, for example, 4 bytes, 8 bytes, 16 bytes.

2. N (Notify Acknowledgement): when set, this flag may direct that the instruction should keep state and a notification be sent to executing agent (e.g., ULP) when all data transmitted is acknowledged.

3. S (Segmentation Directive): this flag may provide a directive for segmentation strategy. Examples include:

a. 00—allow a lower layer (e.g., TCP) to segment the data. The upper layer data is seen as payload by the lower layer (e.g., TCP), which may perform segmentation.

b. 01—allow a ULP (e.g., DDP (direct data placement)) to segment the data. Use the “Immediate Data” field (explained below) as a template header and use the current MSS (maximum segment size) to segment payload. No lower layer (e.g., TCP) segmentation.

c. 10—No segmentation, send as-is.

4. M (Market Insertion): this flag may be used to enable fixed interval markers within the payload. This flag may be associated with one or more subfields, where the value of the one or more subfields may include:

a. Marker Interval to specify an interval at which markers may be inserted.

b. Marker Type to specify the start of the PDU, the end of the PDU, or both.

c. Marker Width, for example, 32 bits, or 64 bits.

Extension 308: this field may comprise a list 310 of address/length pairs 310A, . . . , 310N, list of packets having immediate data 312, or a combination list 314 of address length pairs 310A, . . . , 310N and packets. List 310 of address/length pairs 310A, . . . , 310N may comprise, for example, a scatter/gather list (hereinafter “SGL”), where the address of each address/length pair 310A, . . . , 310N may specify an address in a memory from where data may be accessed, and the length of each address/length pair 310A, . . . , 310N may specify the size of the data to be accessed at the corresponding address. List of packets may comprise immediate data 312A, . . . , 312N. Combination list 314 may comprise both address/length pairs 314A and immediate data 314B. In an embodiment, extension subfields may comprise CRC data that may include a start tag 316 (labeled “S”) to indicate data at which a CRC calculation is to start, and an end tag 318 (labeled “E”) to indicate data at which a CRC calculation is to end.

Of course, transmit PDU instruction 300 may comprise more or less fields than those illustrated above.

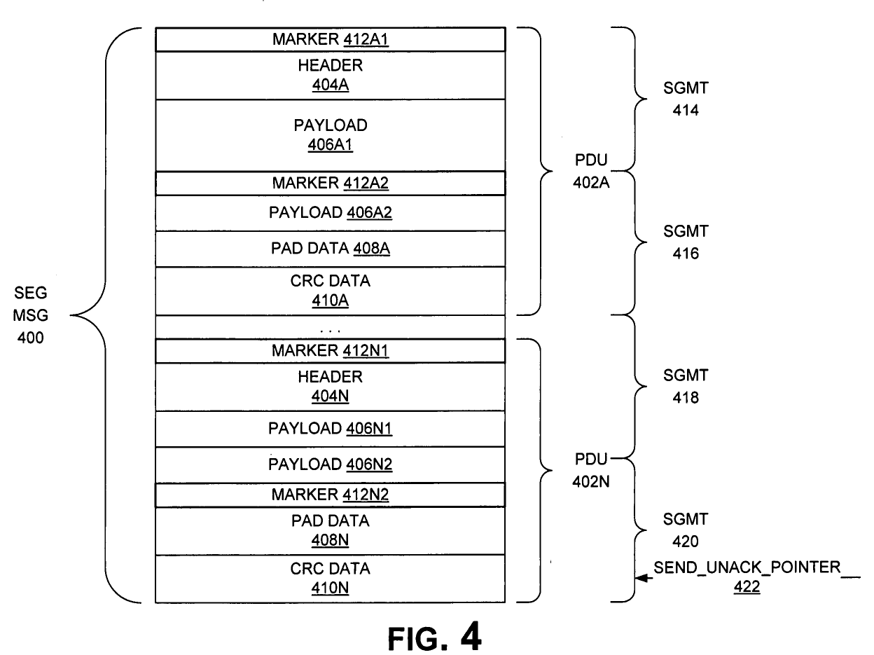

FIG. 4 illustrates a segmentable message 400 comprising PDUs 402A, . . . , 402N. Each PDU 402A, . . . , 402N may comprise a header 404A, . . . , 404N, payload 406A1, 406A2, . . . , 406N1, 406N2, pad data 408A, . . . , 408N, CRC data 410A, . . . , 410N, and one or more markers 412A1, 412A2, . . . , 412N1, 412N2. Segmentable message 400 may be divided-up to comprise one or more segments 414, 416, 418, 420. Each segment 414, 416, 418, 420 may comprise one or more PDUs, or a portion thereof. Segmentable message 400 may have a maximum message size (“MMS”), and each segment 414, 416, 418, 420 may have a maximum segment size (“MSS”). Each segment 414, 416, 418, 420 may begin with a header 404A, . . . , 404N, or with a marker 412A1, 412A2, . . . , 412N1, 412N2. In an embodiment, data for PDUs 402A, . . . , 402N may be obtained in a manner so that a maximum number of markers 412A1, 412A2, . . . , 412N1, 412N2 may be inserted. Consequently, segments may be of size MSS and/or of size MSS—marker size. Upon transmission and acknowledgement by receiving node of a segment 414, 416, 418, 420, or portion thereof, send_unack_pointer 422 may point to a byte of data in a segment 414, 416, 418, 420 that was last acknowledged by a receiving node.

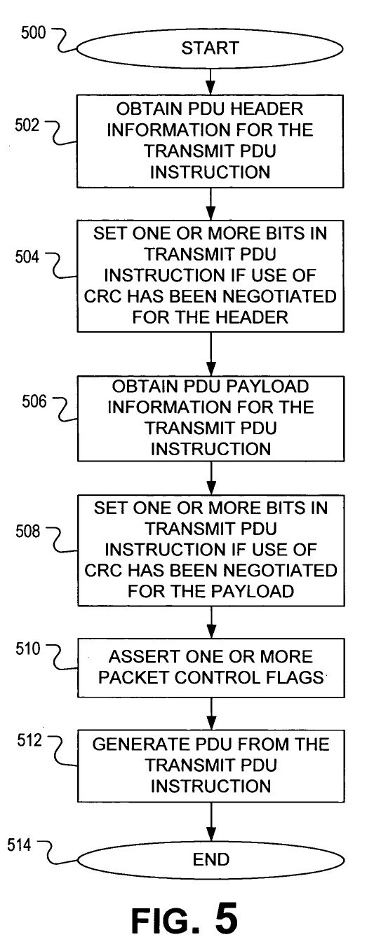

FIG. 5 is a flowchart illustrating how a PDU may be created from a transmit PDU instruction in an embodiment. The method begins at block 500 and continues to block 502 where PDU header information for the transmit PDU instruction 300 may be obtained from a ULP. PDU header information may be specified by N number of immediate data extensions and/or M number of address/length extensions. Each immediate data extension or address/length extension may be stored in a corresponding number extension fields. The method may continue to block 504.

At block 504, one or more bits in the transmit PDU instruction 300 may be set if use of a CRC has been negotiated for the header. Use of a CRC may be negotiated between a sender and recipient of data. For example, the S-bit of the extension field 308 may be set with the first byte of the header, and the E-bit of the extension field 308 may be set with the last byte of the header. The method may continue to block 506.

At block 506, PDU payload information for the transmit PDU instruction 300 may be obtained from a ULP. PDU payload information may be specified by N number of immediate data extensions and/or M number of address/length extensions. Each immediate data extension or address/length extension may be stored in a corresponding number Extension fields. The method may continue to block 508.

At block 508, one or more bits in the transmit PDU instruction 300 may be set if use of a CRC has been negotiated for the payload. For example, the S-bit of the optional Extension field may be set with the first byte of the payload, and the E-bit of the optional Extension field may be set with the last byte of the payload. The method may continue to block 510.

At block 510, one or more packet control flags may be asserted. Asserting one or more packet control flags may comprise setting or providing values for one or more packet control flags including any one or more of the following: providing a Pad Pattern, specifying a Pad Alignment, setting the Notify Acknowledgement flag, specifying a segmentation directive, specifying a market interval, specifying a marker type, and specifying a marker width. This list is not exhaustive, and may furthermore comprise more or less flags than the examples provided without departing from embodiments of the invention. The method may continue to block 512.

At block 512, a PDU 402A, . . . , 402N may be generated from the transmit PDU instruction. Generation of a PDU 402A, . . . , 402N may comprise creating a header 402 and payload 404 from the extension field 308 of the transmit PDU instruction 300. Generation of a PDU 402A, . . . , 402N may further comprise applying one or more operations associated with PDU control flags 304, such as padding the PDU 402A, . . . , 402N and inserting markers 412A1, 412A2, . . . , 412N1, 412N2 in accordance with a subfield 306A, . . . , 306N of PDU control flags 304; as well as calculating and inserting CRC data 410A, . . . , 410N. Generation of a PDU 402A, . . . , 402N may further comprise other operations not described herein, where such other operations may be in accordance with specific protocols. For example, certain ULPs may require that upper layer payload be merged with the payload 406A1, 406A2, . . . , 406N1, 406N2 of PDU 402A, . . . , 402N. However, embodiments of the invention do not require such other operations, nor are they limited to the example of the other operation described above.

As an example, generation of PDU 402A from a transmit PDU instruction 300 having a combination list 314 may comprise:

1. Creating a header 404A from one or more address/length pairs 314A.

2. Creating payload 406A1, 406A2 from one or more immediate data 314A.

3. If use of CRC has been negotiated for the header 402 and/or payload 404, calculate the CRC over the one or more address/length pairs 314A and/or immediate data 314B to create CRC data 410A.

4. Insert the CRC data 410A in the PDU 402A.

5. Insert pad data 408A in accordance with a subfield 306A, . . . , 306N of PDU control flags 304.

6. Insert one or more markers 412A1, 412A2 in accordance with a subfield 306A, . . . , 306N of PDU control flags 304.

Generated PDU 402A, . . . , 402N may be written to a send buffer, such as a TCP send buffer. TCP layer may perform segmentation on PDU 402A, . . . 402N, and transmit.

At block 514, the method of FIG. 5 may end. One or more PDUs may be created according to the method of FIG. 5. In an embodiment, PDUs may be created until a message has been completed.

Referring back to FIG. 2, at block 204, an MSB corresponding to segmentable message 400 may be created. An “MSB” refers to a structure that may be created to keep track of a message. For example, an MSB structure may track the message segment length, the starting sequence number, and the possible variation in segment size due to marker insertion. An MSB 600 may be used to maintain message boundaries so that retransmits may be performed on the same segments. A single MSB may comprise information about all of the segments for one message.

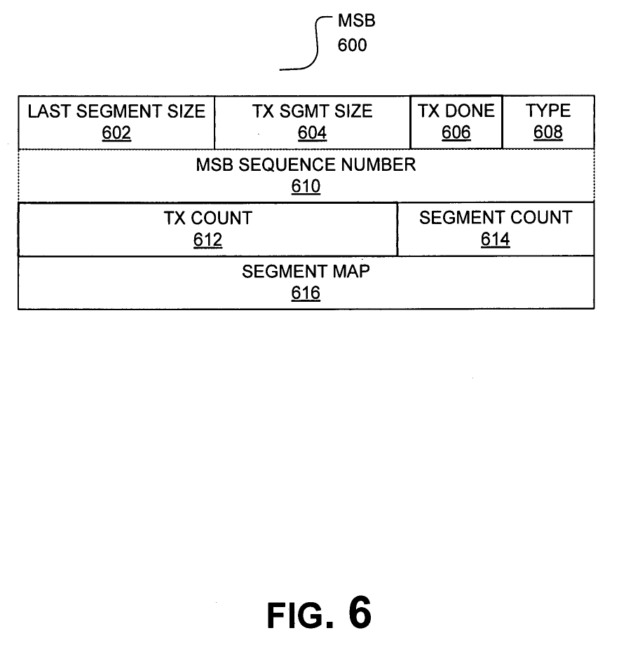

FIG. 6 illustrates an MSB 600 according to an embodiment. An MSB 600 may comprise one or more of the following fields:

Last_segment_size 602: may indicate the size of a last segment, where a last segment may refer to a last one of multiple segments, or the only one of one segment. Size of segments may be in bytes (B), for example. In an embodiment, this field may be 12 bits. This field may be populated by transmit PDU instruction 300.

Transmit_segment_size 604 (labeled “TX SGMT SIZE”): may indicate the MSS of each segment of the message corresponding to the MSB (except the last segment). Size of segments may be in bytes, for example. In an embodiment, the size of this field may be stored using log2(MSS)−1. For example, this field may be 12 bits to support a maximum transmit_segment_size (e.g., MSS) of 4 Kbytes. This field may be populated by transmit PDU instruction 300, and may be used to calculate the size of a message corresponding to the MSB.

Transmit_done 606: a flag that may indicate that all message segments have been transmitted. In an embodiment, this field may be one bit, for example, 0=not transmitted, 1=transmitted. This field may be populated during transmits and retransmits.

Type 608: a flag that may indicate if the MSB 600 describes one segment (hereinafter a “short segment”), or multiple segments (hereinafter a “long segment”). In an embodiment, this field may be one bit, for example, 0=short segment, 1=long segment. This field may be populated by a transmit PDU instruction 300.

MSB_sequence_number 610: a number that may initially correspond to a sequence number of the first segment, where the sequence number may be determined by a lower layer protocol. Each time a segment is transmitted, this number may be incremented by the size of the segment transmitted so that this number points to the first byte of a next segment. When the last segment is transmitted, this number may correspond to the last byte of the segment that was last transmitted. May be reset where a retransmit is required. In an embodiment, this field may be 32 bits. This field may be populated by a transmit PDU instruction 300, and may be updated during a transmit or a retransmit. In an embodiment, send_unack_pointer 422 may be less than or equal to MSB_sequence_number 610, since receiving node can't acknowledge segments that have not been received.

Transmit_count (labeled “TX COUNT”) 612: may indicate the total number of segments that have been transmitted. In an embodiment, segments may be identified starting with segment 0, and transmit_count 612 may be the total number of segments minus one. In an embodiment, this field may be 6 bits calculated from log2(MMS/MSS)−1, where MMS refers to a maximum message size. This field may be populated during a transmit or a retransmit.

Segment_count 614: may refer to the total number of segments. In an embodiment, segments may be identified starting with segment 0, and transmit_count 612 may be the total number of segments minus one. In an embodiment, this field may be 6 bits calculated from log2(MMS/MSS−marker size). This field may be populated by transmit PDU instruction 300.

Segment_map 616: a block that may include a flag for each segment, except the last segment, to indicate if a segment is of size MSS or (MSS−marker size). (The size of the last segment is indicated in the field last_segment_size 602.) In an embodiment, this field may be 1 bit per segment, for example, 0=MSS, 1=(MMS−marker size), where the first segment may correspond to bit zero. This field may be populated by transmit PDU instruction 300.

Of course, MSB 600 may comprise additional fields, including but not limited to, one or more reserved fields (not shown) to store other information.

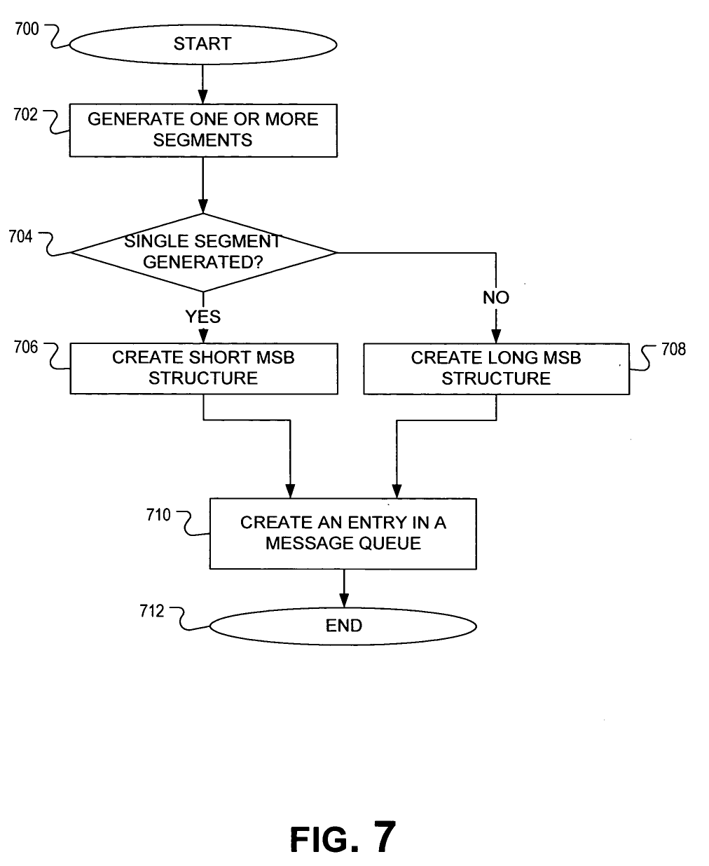

FIG. 7 is a flowchart illustrating how an MSB 600 may be created. The method begins at block 700 and continues to block 702 where one or more segments may be generated. If the size of the message is less than or equal to the MSS, then one segment may be generated. A single segment may be created by generating a segment having a size greater than or equal the size of the message, and less than or equal to MSS. Certain messages, such as command messages, are small enough so that only a single segment is required. If the size of the message is greater than the MSS, then a plurality of segments may be generated. A plurality of segments may be generated by generating a segment of size MSS or (MMS−marker size) until a last segment size of size <=MSS is created. (The last segment size may also be less than (MMS−marker size.) The method may continue to block 704.

At block 704, it may be determined whether one segment was generated or a plurality of segments was generated. If one segment was generated, then the method may continue to block 706. If a plurality of segments were generated, then the method may continue to block 708.

At block 706 (a single segment generated), a short MSB structure may be created. A short MSB structure may comprise the following fields: last_segment_size 602, transmit_done 606, type 608, and MSB_sequence_number 610. In an embodiment, a short MSB structure may comprise populating last_segment_size 602 with the size of the last segment; populating type 608 with a value indicating a short MSB structure; and populating MSB_sequence_number 610 with a starting sequence number of the segment. MSB_sequence_number 610 may be updated to the ending sequence number of the segment upon transmission of the segment. Transmit_done 606 may be populated once the segment has been transmitted. The method may continue to block 710.

At block 708 (a plurality of segments generated), a long MSB structure may be created. In an embodiment, creating a long MSB structure may comprise creating a structure having the following fields: last_segment_size 602, transmit_segment_size 604, transmit_done 606, type 608, MSB_sequence_number 610; transmit_count 612; segment count 614; and segment map 616. The long MSB structure may be created by populating last_segment_size 602 with the size of the last segment; populating type 608 with a value indicating a long MSB structure; populating MSB_sequence_number 610 with a sequence number of the first segment; populating segment count 614 with the total number of segments created minus one; and populating segment map 616 with (MSS or MSS−marker size). Transmit_count 612 and MSB_sequence_number 610 may be updated upon completion of each segment. Transmit_done 606 may be populated once the last segment has been transmitted. In an embodiment, the method may continue to block 712. In another embodiment, the method may continue to block 710.

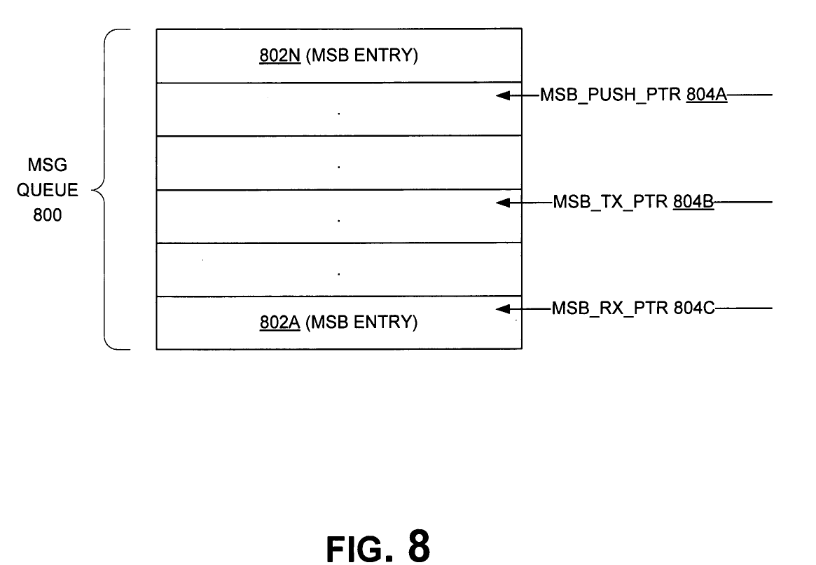

At block 710, an entry in a message queue may be created. This block may be performed where, for example, a plurality of segmentable messages 400 may be transmitted prior to receiving confirmation that one or more previously transmitted segments have been acknowledged. As illustrated in FIG. 8, a message queue 800 may comprise one or more entries 802A, . . . , 802N, where each entry 802A, . . . , 802N may correspond to a segmentable message 400. An entry 802A, . . . , 802N that corresponds to a segmentable message 400 means that the entry may reference or hold an MSB structure that corresponds to the segmentable message 400. Message queue 800 may be associated with one or more queue management pointers 804A, . . . , 804N to manage the entries 802A, . . . , 802N. For example, in an embodiment, one or more pointers 804A, 804B, 804C may comprise the following:

MSB_push_pointer 804A: a pointer that may be maintained by transmit PDU instruction 300, and that may point to an MSB entry 802A, . . . , 802N in message queue 800 where a next MSB 600 may be located. When a new MSB 600 is placed on message queue 800, MSB push pointer 804A may be advanced. In a circular queue, this pointer should not advance beyond MSB_receive_pointer 804C (discussed below).

MSB_transmit_pointer (labeled “MSB_TX_PTR”) 804B: a pointer that may be maintained by transmitter 136 of circuitry 134, and may point to an MSB entry 802A, . . . , 802N in message queue 800 that references an MSB 600 corresponding to a segmentable message 400 that is being currently transmitted. Transmitter 136 may advance this pointer when it finishes transmitting all segments of the current message. This pointer should not advance beyond MSG_push pointer_804A.

MSB_receive_pointer (labeled “MSB_RX_PTR”) 804C: a pointer that may be maintained by receiver 138 of circuitry 134, and may point to an MSB entry 802A, . . . , 802N in message queue 800 that references an MSB 600 corresponding to a segmentable message 400 to which send_unack_pointer 422 points. Receiver 138 may advance the MSB_receive_pointer 804C when it has received an acknowledgment for the entire message represented by the MSB 600. When this pointer is advanced, the previous entry 802A, . . . , 802N may be freed. This pointer should not advance beyond MSB_transmit_pointer 804A.

At block 712, the method of FIG. 7 may end.

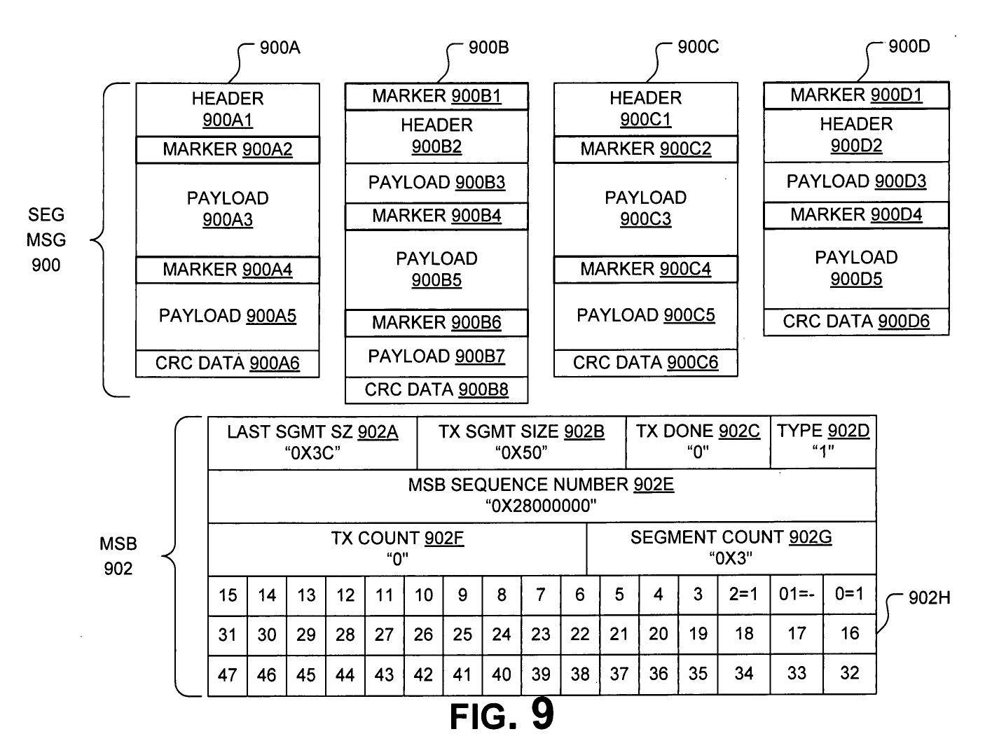

FIG. 9 illustrates an MSB 902, having a structure like MSB 600, created in accordance with a transmit PDU instruction 300, where the MSB 902 corresponds to a segmentable message 900 having a structure like segmentable message 400. Segmentable message 900 may comprise a long MSB structure, and may comprise segments 0-3 900A, 900B, 900C, and 900D, respectively. Segment 0 900A may comprise header 900A1, markers 900A2, 900A4, payload 900A3, 900A5, and CRC data 900A6. Segment 1 900B may comprise markers 900B1, 900B4, 900B6, header 900B2, payload 900B3, 900B5, 900B7, and CRC data 900B8. Segment 2 900C may comprise header 900C1, markers 900C2, 900C4, payload 900C3, 900C5, and CRC data 900C6. Segment 3 900D may comprise markers 900D1, 900D4, header 900D2, payload 900D3, 900D5, and CRC data 900D6.

As an example, message 900 may have a message size of 292B, where MSS=80 B. Assuming segment 1 900B has a segment size=MSS=80 B, then both segment 0 900A and segment 2 900C may have a segment size=MSS−marker size. Last segment 3 900D may have a segment size<=MSS.

In this example, MSB 902 may support a message having up to 48 segments (segments 0 through 47), as represented by bits 0 through 47 in segment_map 902H. MSB 902 may be created by populating last_segment_size 902A with the size of segment 900D, which is equal to 0X3C in this example; populating type 902D with “1” to indicate a long MSB structure; populating MSB_sequence_number 902E with “0X28000000” a sequence number of segment 900A; populating segment_count 902G with “0X3” to indicate the total number of segments (i.e., 4 segments) minus one; and populating segment_map 902H with (MSS or MSS−marker size) by setting both bit 0 and bit 2 to “1” to indicate a size of (MSS−marker size), and setting bit 1 to “0” to indicate a size of MSS. Since bit 3 represents segment 3, and segment 3 is a last segment, bit 3 is not set in this example. Instead, the size of segment 3 is indicated in the field last_segment_size 902A. Transmit_count 612 and MSB_sequence_number 610 may each be updated each time a segment is transmitted. Transmit_segment_size 902B may be populated with the MSS of segments in the MSB 902. Upon completing transmission of last segment (i.e., segment 3 900D), transmit done 902C may be populated with a “1”.

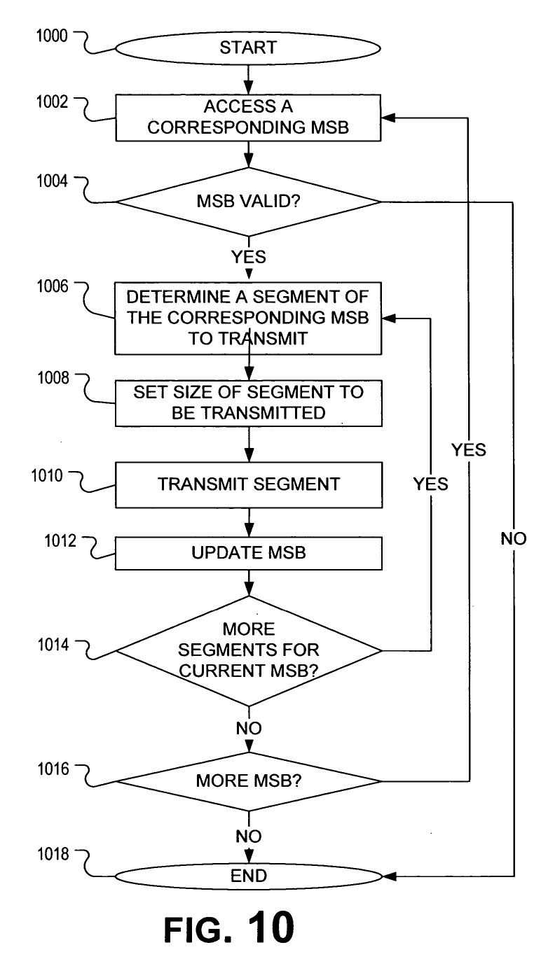

Referring back to FIG. 2, at block 206, segmentable message 400 may be transmitted in accordance with the MSB. The flowchart of FIG. 10 illustrates a method for transmitting one or more segments of a segmentable message 400 according to an embodiment of the invention. The method may begin at block 1000, and continue to block 1002 where an MSB 600 corresponding to a segmentable message 400 having one or more segments to be transmitted may be accessed. If there is one segmentable message 600 (e.g., no message queue 800 is being used), then an MSB 600 corresponding to a single segmentable message 400 may be accessed. If there is more than one segmentable message 600 (e.g., a message queue 800 is being used), then the MSB 600 pointed to by MSB_transmit_pointer 804B may be accessed.

At block 1004, it may be determined if the MSB 600 is valid. Determining if an MSB 600 is valid may comprise, for example, determining that a minimum number of MSB fields have been completed, and that there is at least one segment ready to be transmitted. If the MSB 600 is valid, the method may continue to block 1006. Otherwise if the MSB 600 is invalid, the method may continue to block 1018.

At block 1006, a segment to transmit may be determined. This may be determined by checking the type 608 field to determine if this MSB 600 is a short MSB structure or a long MSB structure. If MSB 600 is a short MSB structure (e.g., type 608 is equal to “0”), then there is only one segment to be transmitted. If MSB 600 is a long MSB structure (e.g., type 608 is equal to “1”), then the segment to be transmitted may be determined by transmit_count 612. The method may continue to block 1008.

At block 1008, the size of the segment to be transmitted may be determined. If MSB 600 is a short MSB structure (e.g., type 608 is equal to “0”), the size may be set to last_segment_size 602. If MSB 600 is a long MSB structure (e.g., type 608 is equal to “1”), then the transmit_count 612 field may be compared to the segment_count 614 field. If the transmit_count 612 field is equal to the segment_count 614 field, then the size of the segment to be transmitted may be set to last_segment_size 602. If the transmit_count 612 field is not equal to the segment_count 614 field, then the size of the segment to be transmitted may be set to the size indicated by the corresponding bit in segment_map 616 (i.e., MSS or MSS−marker size). In an embodiment, a transmit_size field (not shown) for the particular protocol being used (e.g., TCP) may be set to the size of the segment to be transmitted so that the receiving node of the segment knows whether the entire segment is received. The method may continue to block 1010.

At block 1010, the segment may be transmitted. Transmission of a segment may comprise transmitting the segment in accordance with a transmission protocol. Examples of transmission protocols may include TCP (Transmission Control Protocol), or UDP (User Datagram Protocol). Of course, embodiments of the invention are not limited by these examples, and other transmission protocols may be used without departing from embodiments of the invention.

At block 1012, the MSB 800 may be updated. Updating the MSB may comprise updating one or more fields. If MSB 600 is a short MSB structure (e.g., type 608 is equal to “0”), then the following may be performed: incrementing the MSB_sequence_number 610 by the size of the transmitted segment, and setting transmit_done 606 (e.g., to “1”) to indicate that the segmentable message 400 corresponding to the MSB 800 has been transmitted. If MSB 600 is a long MSB structure (e.g., type 608 is equal to “1”), then the MSB_sequence_number 610 may be incremented by the size of the transmitted segment, and transmit_count 612 may be incremented by the number of segments just transmitted (e.g., one). If the transmitted segment is a last segment (e.g., transmit_count 612 is equal to the segment_count 614), then the transmit_done 606 field may be set (e.g., to “1”) to indicate that the segmentable message 400 corresponding to the MSB 800 has been transmitted.

At block 1014, it may be determined if there are one or more additional segments to be transmitted for the current MSB. If MSB 600 is a long MSB structure (e.g., type 608 is equal to “1”), then it may be determined if the transmitted segment was the last segment. If the transmitted segment was not the last segment (e.g., transmit_count 612 is not equal to the segment_count 614), then the method may continue back to block 1006. If the transmitted segment was a last segment (e.g., transmit_count 612 is equal to the segment_count 614) or if MSB 600 is a short MSB structure (e.g., type 608 is equal to “0”), then there are no more segments, and the method may continue to block 1016.

At block 1016, it may be determined if there are more MSBs 600. This may be determined by determining if there is a message queue 800. If a message queue 800 is being used, then the MSB 600 pointed to by MSB_transmit_pointer 804B may be incremented, and the method may continue back to block 1002. If there are no more MSBs 600, then the method may continue to block 1018.

The method of FIG. 2 may continue from block 206 to block 208.

At block 208, the method of FIG. 2 may end.

At block 1018, the method of FIG. 10 may end.

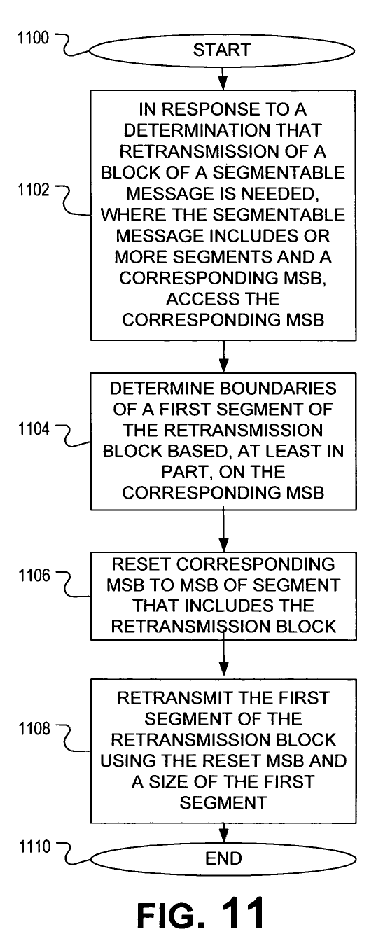

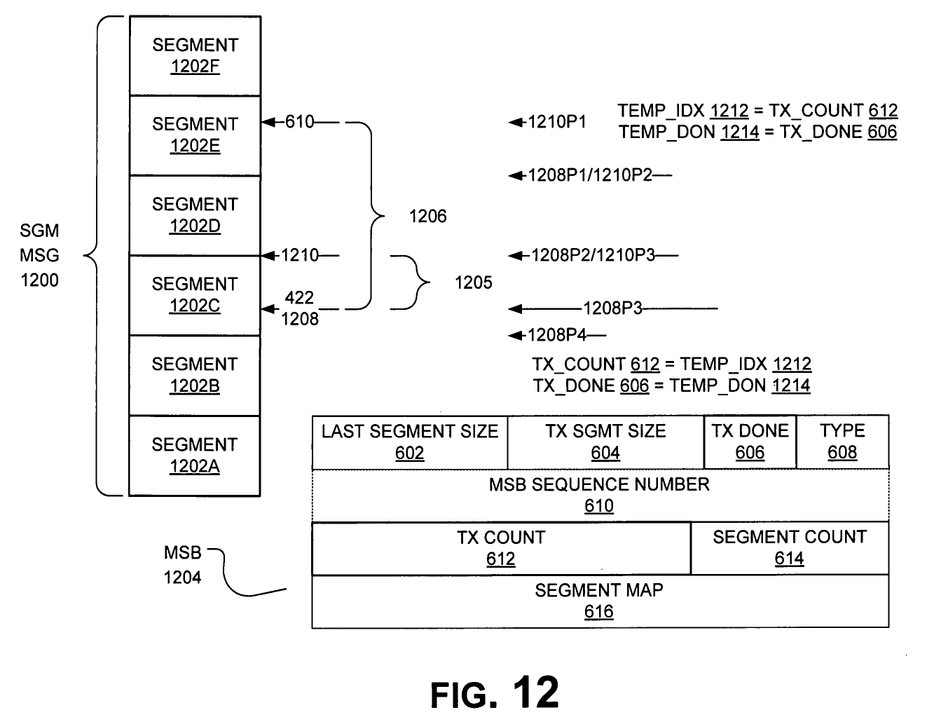

FIG. 11 illustrates a method for retransmitting one or more segments of a segmentable message 400, as further illustrated in the block diagram of FIG. 12, according to an embodiment of the invention. The method begins at block 1100 and continues to block 1102 where, in response to a determination that retransmission of a block 1206 (“retransmission block”) of a segmentable message 1200 is needed, where the segmentable message 1200 may include one or more segments 1202A, . . . , 1202F and a corresponding MSB 1204, accessing the corresponding MSB. If there is more than one MSB 600 (e.g., if a message queue 800 is utilized), then MSB_receive_pointer 804C may be accessed to determine the corresponding MSB 1404. If there is one MSB 600 (e.g., no message queue 800 is utilized), then the corresponding MSB 1404 may comprise the single MSB 600.

In an embodiment, retransmission may be determined by a lower layer protocol. For example, TCP may determine that a block of a segmentable message has not been acknowledged, and upon expiration of a retransmit timer, a NIC, for example, may determine what needs to be transmitted.

A “retransmission block” refers to one or more segments, or portions thereof, of a segmentable message for which an acknowledgement has not been received. Since send_unack_pointer 422 may point to a byte of data in a segment that was last acknowledged by a receiving node, segments, or portions thereof, that are greater than send_unack_pointer 422 may be segments that have not been acknowledged. For example, in FIG. 12, where send_unack_pointer 422 points to a portion of segment 1202C, other portions of segment 1202C, segment 1202D, and segment 1202E have not been acknowledged.

A “retransmission” refers to a transmission that is subsequent to one or more previous transmissions of one or more segments, or one or more portions thereof, where the one or more segments were not acknowledged as being received on the transmission. “Transmission” of a segment refers to the segment being transmitted by a transmitting node, and “acknowledgement” of a segment refers to notification of the receipt of a segment by a receiving node in response to transmission of the segment by a transmitting node.

At block 1104, the boundaries of a first segment 1205 of the retransmission block 1206 may be determined based, at least in part, on the corresponding MSB. Segments of the retransmission block 1206 subsequent to the first segment 1205 may be retransmitted upon retransmission of the first segment. In an embodiment, the boundaries of the first segment of the retransmission block may comprise a lower boundary defined by the first byte of data in first segment 1205, and an upper boundary defined by the last byte of data in first segment 1205. In the example of FIG. 12, the lower boundary is shown at 1208 and the upper boundary is shown at 1210. The upper boundary 1210 and lower boundary 1208 of the first segment 1205 of retransmission block 1206 may be determined by examining the corresponding MSB 1204.

A preliminary upper boundary 1210P1 of first segment 1205 of retransmission block 1206 may be set to the MSB_sequence_number 610 (which corresponds to the last byte of the segment that was last transmitted, e.g., segment 1202E) of the corresponding MSB 1204. Furthermore, a temporary index field 1212 may be set to the transmit_count 612 field of the corresponding MSB 1204, and a temporary done field 1214 may be set to the transmit_done 606 field of the corresponding MSB 1204.

A preliminary lower boundary 1208P1 of first segment 1205 of retransmission block 1206 may be dependent on whether the entire segmentable message 1200 has been completely transmitted (i.e., an attempt was made to transmit each segment 1202A, . . . , 1202F of the segmentable message 1200). If the entire segmentable message 1200 has been completely transmitted, then the preliminary lower boundary 1208P1 may be set based, at least in part, on the last_segment_size 602 (i.e., size of the last segment 1202F of the segmentable message 1200) of the MSB 1204. If the segmentable message 1200 has not been completely transmitted, then the preliminary lower boundary 1208P1 may be set based, at least in part, on the size of the segment that was last transmitted (e.g., segment 1202E). The size of the segment that was last transmitted (e.g., segment 1202E) may be found by using the transmit_count field 612 of the corresponding MSB 1204 to index into the corresponding bit in the segment_map 616. The preliminary lower boundary may then be determined by subtracting the determined size from MSB_sequence_number 610, in this case 1208P1.

If the send_unack_pointer 422 is greater than or equal to the preliminary lower boundary 1208P1, then the upper boundary 1210 may be set to the preliminary upper boundary 1210P1. If the send_unack_pointer 422 is less than the preliminary lower boundary 1208P1, then the following may occur in an interative manner until the send_unack_pointer 422 is greater than or equal to the preliminary lower boundary 1208P1: the new preliminary upper boundary 1210P2 may be set to the current preliminary lower boundary 1208P1, and the new preliminary lower boundary 1208P2 may be set to the current preliminary lower boundary 1208P1 minus the size of the previous segment; the index may be decremented (e.g., by one), and the done flag may indicate incomplete (e.g., set to 0) at the index. This iterative process may rewind the retransmission back to the segment 1202A, . . . , 1202F to which the send_unack_pointer 422 points (e.g., segment 1202B). When the send_unack_pointer 422 is greater than or equal to the preliminary lower boundary (e.g., at 1208P4), the upper boundary 1210 may be set to the current preliminary upper boundary (e.g., 1210P3). In the example of FIG. 12, the send_unack_pointer 422 is greater than or equal to the preliminary lower boundary 1208P1, 1208P2, 1208P3, 1208P4 at 1208P4, and the upper boundary 1210 may be set to the preliminary upper boundary 1210P3. The method may continue to block 1106.

At block 1106, the corresponding MSB 1204 is reset to correspond to the MSB 1204 of the segment that includes first segment 1205 of retransmission block 1206 (e.g., segment 1202C). In an embodiment, this may comprise setting MSB_sequence_number 610 to the upper boundary 1210, setting transmit_count 612 to the index 1212, and setting transmit_done 606 to done 1214. The method may continue to block 1108.

At block 1108, first segment 1205 of retransmission block 1206 may be retransmitted using the reset MSB 800 and the size of first segment 1205 of retransmission block 1208. In an embodiment, the size of first segment 1205 of retransmission block 1208 may be determined by subtracting the send_unack_pointer 422 from the upper boundary 1210. Each subsequent segment of retransmission block 1206 may be retransmitted in accordance with the appropriate transport protocol. The method may continue to block 1110.

At block 1110, the method of FIG. 11 may end.

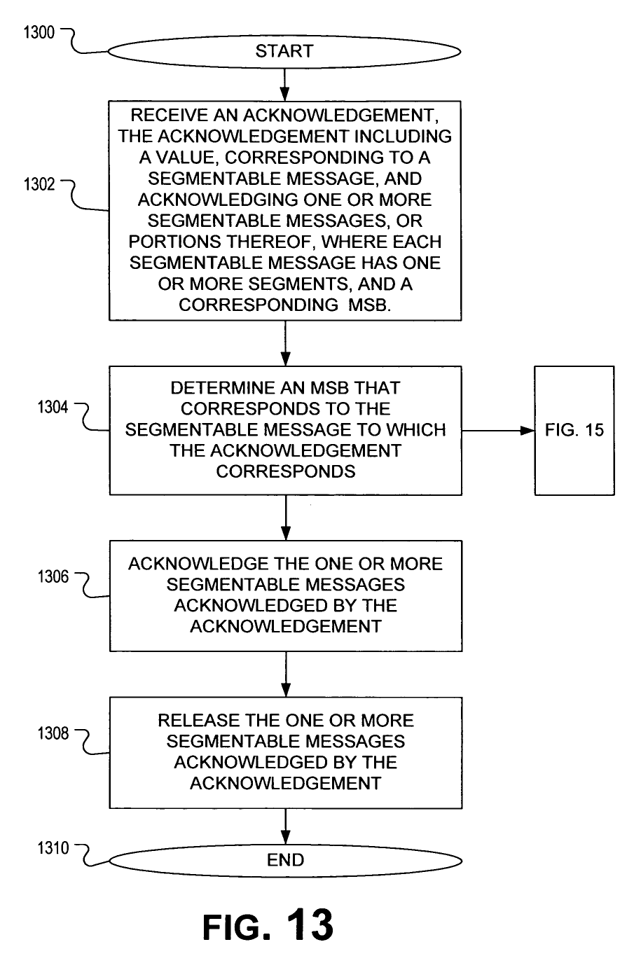

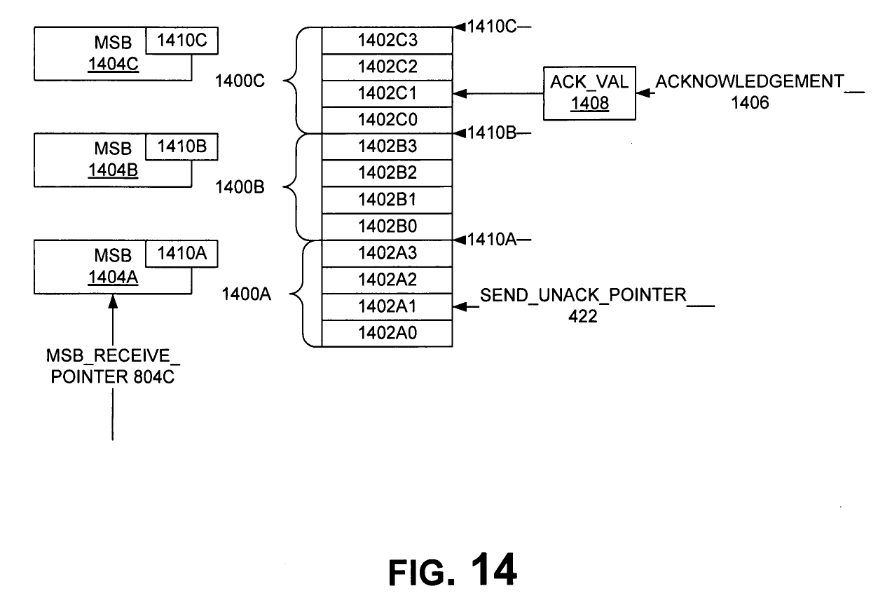

FIG. 13 illustrates a method to receive acknowledgements, as further illustrated by the block diagram of FIG. 14, according to an embodiment. The method begins at block 1300 and continues to block 1302 where an acknowledgement 1406 may be received, where the acknowledgement 1406 may be associated with a value 1408 (“acknowledgement value”, labeled “ACK_VAL”), may correspond to a segmentable message (e.g., 1400C), and may acknowledge one or more segmentable messages, or portions thereof (e.g., 1400B, portion of 1400C), where each segmentable message 1400A, 1400B, 1400C has one or more segments 1402A0, 1402A1, 1402A2, 1402A3, 1402B0, 1402B1, 1402B2, 1402B3, 1402CO, 1402C1, 1402C2, 1402C3, and a corresponding MSB 1404A, 1404B, 1404C. Each MSB may also correspond to an MSB sequence number 1410A, 1410B, 1410C.

An acknowledgment may correspond to a segmentable message if it points to a segment within the segmentable message. An acknowledgement may acknowledge one or more segmentable messages, or portions thereof, if the acknowledgement acknowledges receipt of all or a portion of the segmentable messages 1400. An acknowledgement value associated with an acknowledgement may be a location within segmentable message. The method may continue to block 1304.

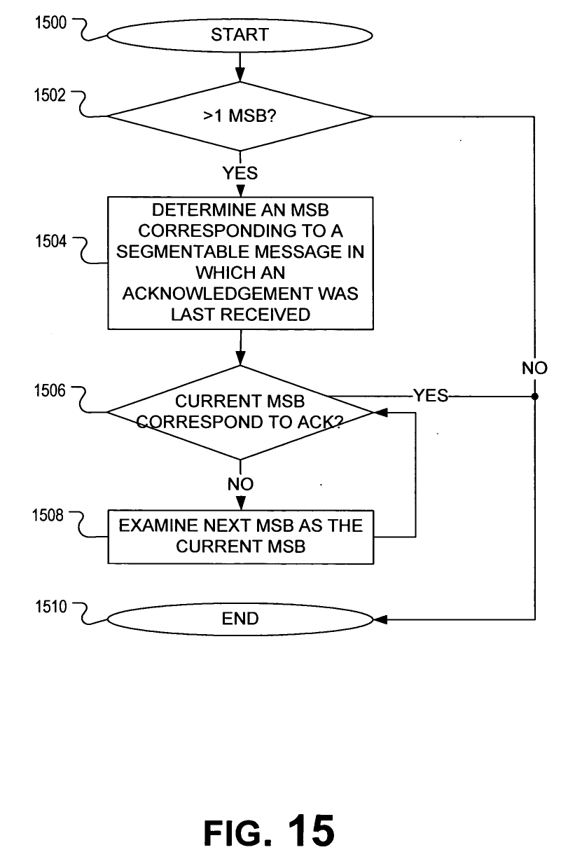

At block 1304, the MSB 1404A, 1404B, 1404C that corresponds to the segmentable message to which the acknowledgement 1406 corresponds (e.g., 1404C) may be determined. In an embodiment, this may be determined according to the flowchart of FIG. 15. The method of FIG. 15 begins at block 1500 and continues to block 1502.

At block 1502, it may be determined if there is more than one MSB (e.g., if a message queue 800 is utilized). If there is more than one MSB (as in the example of FIG. 14), then the method may continue to block 1504. If there is only one MSB, then the MSB is the MSB that corresponds to the segmentable message to which the acknowledgement 1406 corresponds, and the method may continue to block 1510.

At block 1504, an MSB corresponding to a segmentable message in which an acknowledgement was last received (e.g., segmentable message 1400C, and corresponding MSB 1404C) may be determined. Since an acknowledgement may be sent within a segmentable message last received, or may be sent one or more segmentable messages after the segmentable message last received, each segmentable message including and subsequent to the segmentable message in which an acknowledgement was last received may be checked to determine to which of one or more segmentable messages the acknowledgement corresponds.

If there is more than one MSB, then the MSB pointed to by MSB_receive_pointer 804C may be accessed as the current MSB (e.g., 1404A), since MSB_receive_pointer 804C points to the MSB having a segment that was last acknowledged. The method may continue to block 1506.

At block 1506, it may be determined if the current MSB corresponds to the acknowledgement 1406. In an embodiment, determining if the current MSB corresponds to the acknowledgement 1406 may comprise comparing the acknowledgement value 1408 to the MSB sequence_number 1410A, 1410B, 1410C of the current MSB.

If the acknowledgement value 1408 is greater than the MSB_sequence_number 1410A, 1410B, 1410C (i.e., last sequence number of the message) of the current MSB, then the current MSB does not correspond to the acknowledgement 1406. In this case, the acknowledgement 1406 may acknowledge this segmentable message as well as other segmentable messages, and a next MSB may be examined to determine which other segmentable messages may be acknowledged by the acknowledgement 1406. In an embodiment, this may comprise incrementing MSB_receive_pointer 804C to the next MSB.

If the acknowledgement value 1408 is equal to the MSB_sequence_number 1410A, 1410B, 1410C of the current MSB, then the current MSB corresponds to the acknowledgement 1406. In this case, the acknowledgement 1406 may completely acknowledge the segmentable message corresponding to the current MSB.

If the acknowledgement value 1408 is less than the MSB_sequence_number 1410A, 1410B, 1410C of the current MSB (assuming the MSB has not already been previously acknowledged), then the current MSB corresponds to the acknowledgement 1406. In this case, the acknowledgement 1406 may partially acknowledge the segmentable message corresponding to the current MSB.

If the current MSB is not the MSB that corresponds to the acknowledgement 1406, then the method may continue to block 1508. If the current MSB is the MSB that corresponds to the acknowledgement, then the method may continue to block 1510.

At block 1508, the next MSB may be examined as the current MSB. In an embodiment, a next MSB may be examined by incrementing MSB_receive_pointer 804C. The method may continue back to block 1506.

At block 1510, the method of FIG. 15 may end.

Referring back to FIG. 13, at block 1306, the one or more segmentable messages, or portions thereof (.e.g, portion of 1400A, 1400B, portion of 1400C) acknowledged by the acknowledgement 1406 may be acknowledged. This may comprise updating send_unack_pointer 422 to acknowledgement value 1408. Also, if the segmentable message corresponding to the current MSB (e.g., segmentable message 1400C, MSB 1404C) has been completely acknowledged by the acknowledgement 1406, (i.e., the acknowledgement value 1408 is equal to the MSB_sequence_number 610 ), and if there are more MSBs, then MSB_receive_pointer 804C may be incremented to the next MSB since the segmentable message corresponding to the current MSB has been completely acknowledged by the acknowledgement. The method may continue to block 1308.

At block 1308, the one or more segmentable messages acknowledged by the acknowledgement may be released. This may comprise clearing the contents of the one or more corresponding MSBs 1404. The method may continue to block 1310.

At block 1310, the method of FIG. 13 may end.

Conclusion

Therefore, in an embodiment, a method may comprise creating a segmentable message based, at least in part, on a transmit PDU (protocol data unit) instruction, the segmentable message having one or more PDUs, creating an MSB (message segmentation block) corresponding to the segmentable message, and transmitting the segmentable message using the corresponding MSB.

Embodiments of the invention may enable message boundaries to be maintained, which may be useful for upper layer protocols, such as RDMA. Furthermore, embodiments of the invention provide a generic mechanism by which PDUs may be created for any protocol.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
creating a segmentable message based, at least in part, on a transmit PDU (protocol data unit) instruction, the segmentable message having one or more PDUs;
creating an MSB (message segmentation block) corresponding to the segmentable message; and
transmitting the segmentable message using the corresponding MSB.

2. The method of claim 1, wherein said creating a segmentable message based, at least in part, on a transmit PDU instruction comprises:
obtaining PDU header information for the transmit PDU instruction;
setting one or more bits in the transmit PDU instruction if use of CRC has been negotiated for the header;
obtaining PDU payload information for the transmit PDU instruction;
setting one or more bits in the transmit PDU instruction if use of CRC has been negotiated for the payload;
asserting one or more packet control flags; and
generating a PDU from the transmit PDU instruction.

3. The method of claim 1, wherein said creating an MSB corresponding to the segmentable message comprises:
generating one or more segments; and
creating one of a short MSB structure or a long MSB structure.

4. The method of claim 3, additionally comprising creating an entry in a message queue for the MSB.

5. The method of claim 1, wherein said transmitting the segmentable message using the corresponding MSB comprises:
a. accessing the corresponding MSB;
b. if the corresponding MSB is valid, determining a segment of the MSB to transmit;
c. setting a size of the segment to be transmitted;
d. transmitting the segment;
e. updating the corresponding MSB; and
f. if there are more segments to be transmitted, then repeating the method starting at b.

6. The method of claim 5, additionally comprising determining if there is another MSB, and if there is another MSB, then repeating the method.

7. The method of claim 1, additionally comprising retransmitting a block of the segmentable message.

8. The method of claim 7, wherein said retransmitting a block of the segmentable message comprises:
accessing the corresponding MSB;
determining boundaries of a first segment of the retransmission part based, at least in part, on the corresponding MSB;
resetting the corresponding MSB to an MSB of a segment that includes the retransmission block; and
retransmitting the first segment of the retransmission block using the reset MSB and a size of the first segment.

9. The method of claim 1, additionally comprising:
receiving an acknowledgement, the acknowledgement including a value, corresponding to a segmentable message, and acknowledging one or more segmentable messages, or portions thereof, where each segmentable message has one or more segments and a corresponding MSB;
determining an MSB that corresponds to the segmentable meesage to which the acknowledgement corresponds;
acknowledging the one or more segmentable messages acknowledged by the acknowledgement; and releasing the one or more segmentable messages acknowledged by the acknowledgement.

10. The method of claim 9, wherein said determining an MSB that corresponds to the segmentable message to which the acknowledgement corresponds comprises:
if there is more than one MSB, determining an MSB corresponding to the segmentable message in which an acknowledgement was last received; and
if the current MSB does not correspond to the acknowledgement, then examining the next MSB as the current MSB.

11. The method of claim 1, wherein the segmentable message is based on a message-oriented communication protocol.

12. The method of claim 11, wherein the message-oriented communication protocol comprises RDMA (Remote Direct Memory Access).

13. An apparatus comprising:
circuitry to:
create a segmentable message based, at least in part, on a transmit PDU (protocol data unit) instruction, the segmentable message having one or more PDUs;
create an MSB (message segmentation block) corresponding to the segmentable message; and
transmit the segmentable message using the corresponding MSB.

14. The apparatus of claim 13, wherein said circuitry to create a segmentable message based, at least in part, on a transmit PDU instruction comprises circuitry to:
obtain PDU header information for the transmit PDU instruction;
set one or more bits in the transmit PDU instruction if use of CRC has been negotiated for the header;
obtain PDU payload information for the transmit PDU instruction;
set one or more bits in the transmit PDU instruction if use of CRC has been negotiated for the payload;
assert one or more packet control flags; and
generate a PDU from the transmit PDU instruction.

15. The apparatus of claim 13, wherein said circuitry to create an MSB corresponding to the segmentable message comprises circuitry to:
generate one or more segments; and
create one of a short MSB structure or a long MSB structure.

16. The apparatus of claim 15, the circuitry to additionally create an entry in a message queue for the MSB.

17. The apparatus of claim 13, wherein said circuitry to transmit the segmentable message using the corresponding MSB comprises circuitry to:
a. access the corresponding MSB;
b. if the corresponding MSB is valid, determine a segment of the MSB to transmit;
c. set a size of the segment to be transmitted;
d. transmit the segment;
e. update the corresponding MSB; and
f. if there are more segments to be transmitted, then repeat the method starting at b.

18. The apparatus of claim 17, the circuitry to additionally determine if there is another MSB, and if there is another MSB, then the circuitry to repeat the method.

19. The apparatus of claim 13, the circuitry to additionally retransmit a block of the segmentable message.

20. The apparatus of claim 19, wherein said circuitry to retransmit a block of the segmentable message comprises circuitry to:
access the corresponding MSB;
determine boundaries of a first segment of the retransmission part based, at least in part, on the corresponding MSB;
reset the corresponding MSB to an MSB of a segment that includes the retransmission block; and
retransmit the first segment of the retransmission block using the reset MSB and a size of the first segment.

21. The apparatus of claim 13, the circuitry to additionally:
receive an acknowledgement, the acknowledgement including a value, corresponding to a segmentable message, and acknowledging one or more segmentable messages, or portions thereof, where each segmentable message has one or more segments and a corresponding MSB;
determine an MSB that corresponds to the segmentable meesage to which the acknowledgement corresponds;
acknowledge the one or more segmentable messages acknowledged by the acknowledgement; and
release the one or more segmentable messages acknowledged by the acknowledgement.

22. The apparatus of claim 21, wherein said circuitry to determine an MSB that corresponds to the segmentable message to which the acknowledgement corresponds comprises circuitry to:
if there is more than one MSB, determine an MSB corresponding to the segmentable message in which an acknowledgement was last received; and
if the current MSB does not correspond to the acknowledgement, then examine the next MSB as the current MSB.

23. A system comprising:
a circuit board having a circuit card slot;
a circuit card coupled to the circuit board via the circuit card slot, the circuit card having circuitry to:
create a segmentable message based, at least in part, on a transmit PDU (protocol data unit) instruction, the segmentable message having one or more PDUs;
create an MSB (message segmentation block) corresponding to the segmentable message; and
transmit the segmentable message using the corresponding MSB.

24. The system of claim 23, wherein said circuitry to create a segmentable message based, at least in part, on a transmit PDU instruction comprises circuitry to:
obtain PDU header information for the transmit PDU instruction;
set one or more bits in the transmit PDU instruction if use of CRC has been negotiated for the header;
obtain PDU payload information for the transmit PDU instruction;
set one or more bits in the transmit PDU instruction if use of CRC has been negotiated for the payload;
assert one or more packet control flags; and
generate a PDU from the transmit PDU instruction.

25. The system of claim 23, wherein said circuitry to create an MSB corresponding to the segmentable message comprises circuitry to:
generate one or more segments; and
create one of a short MSB structure or a long MSB structure.

26. The system of claim 25, the circuitry to additionally create an entry in a message queue for the MSB.

27. The system of claim 23, wherein said circuitry to transmit the segmentable message using the corresponding MSB comprises circuitry to:
a. access the corresponding MSB;
b. if the corresponding MSB is valid, determine a segment of the MSB to transmit;
c. set a size of the segment to be transmitted;
d. transmit the segment;
e. update the corresponding MSB; and
f. if there are more segments to be transmitted, then repeat the method starting at b.

28. The system of claim 27, the circuitry to additionally determine if there is another MSB, and if there is another MSB, then the circuitry to repeat the method.

29. The system of claim 23, the circuitry to additionally retransmit a block of the segmentable message.

30. The system of claim 29, wherein said circuitry to retransmit a block of the segmentable message comprises circuitry to:
access the corresponding MSB;
determine boundaries of a first segment of the retransmission part based, at least in part, on the corresponding MSB;
reset the corresponding MSB to an MSB of a segment that includes the retransmission block; and
retransmit the first segment of the retransmission block using the reset MSB and a size of the first segment.

31. The system of claim 23, the circuitry to additionally:
receive an acknowledgement, the acknowledgement including a value, corresponding to a segmentable message, and acknowledging one or more segmentable messages, or portions thereof, where each segmentable message has one or more segments and a corresponding MSB;
determine an MSB that corresponds to the segmentable meesage to which the acknowledgement corresponds;
acknowledge the one or more segmentable messages acknowledged by the acknowledgement; and
release the one or more segmentable messages acknowledged by the acknowledgement.

32. The system of claim 31, wherein said circuitry to determine an MSB that corresponds to the segmentable message to which the acknowledgement corresponds comprises circuitry to:
if there is more than one MSB, determine an MSB corresponding to the segmentable message in which an acknowledgement was last received; and
if the current MSB does not correspond to the acknowledgement, then examine the next MSB as the current MSB.

33. An article of manufacture having stored thereon instructions, the instructions when executed by a machine, result in the following:
creating a segmentable message based, at least in part, on a transmit PDU (protocol data unit) instruction, the segmentable message having one or more PDUs;
creating an MSB (message segmentation block) corresponding to the segmentable message; and
transmitting the segmentable message using the corresponding MSB.

34. The article of claim 33, wherein said instructions that result in creating a segmentable message based, at least in part, on a transmit PDU instruction comprise instructions that result in:
obtaining PDU header information for the transmit PDU instruction;
setting one or more bits in the transmit PDU instruction if use of CRC has been negotiated for the header;
obtaining PDU payload information for the transmit PDU instruction;
setting one or more bits in the transmit PDU instruction if use of CRC has been negotiated for the payload;
asserting one or more packet control flags; and
generating a PDU from the transmit PDU instruction.

35. The article of claim 33, wherein said instructions that result in creating an MSB corresponding to the segmentable message comprise instructions that result in:
generating one or more segments; and
creating one of a short MSB structure or a long MSB structure.

36. The article of claim 35, the instructions additionally resulting in creating an entry in a message queue for the MSB.

37. The article of claim 33, wherein said instructions that result in transmitting the segmentable message using the corresponding MSB comprise instructions that result in:
a. accessing the corresponding MSB;
b. if the corresponding MSB is valid, determining a segment of the MSB to transmit;
c. setting a size of the segment to be transmitted;
d. transmitting the segment;
e. updating the corresponding MSB; and
f. if there are more segments to be transmitted, then repeating the method starting at b.

38. The article of claim 37, the instructions additionally resulting in determining if there is another MSB, and if there is another MSB, then repeating the method.

39. The article of claim 33, the instructions additionally resulting in retransmitting a block of the segmentable message.

40. The article of claim 39, wherein said instructions that result in retransmitting a block of the segmentable message comprise instructions that result in:
accessing the corresponding MSB;
determining boundaries of a first segment of the retransmission part based, at least in part, on the corresponding MSB;
resetting the corresponding MSB to an MSB of a segment that includes the retransmission block; and
retransmitting the first segment of the retransmission block using the reset MSB and a size of the first segment.

41. The article of claim 40, the instructions additionally resulting in:
receiving an acknowledgement, the acknowledgement including a value, corresponding to a segmentable message, and acknowledging one or more segmentable messages, or portions thereof, where each segmentable message has one or more segments and a corresponding MSB;
determining an MSB that corresponds to the segmentable meesage to which the acknowledgement corresponds;
acknowledging the one or more segmentable messages acknowledged by the acknowledgement; and
releasing the one or more segmentable messages acknowledged by the acknowledgement.

42. The article of claim 41, wherein said instructions that result in determining an MSB that corresponds to the segmentable message to which the acknowledgement corresponds comprise instructions that result in:
if there is more than one MSB, determining an MSB corresponding to the segmentable message in which an acknowledgement was last received; and
if the current MSB does not correspond to the acknowledgement, then examining the next MSB as the current MSB.
